(19) United States
(12) Patent Application Publication
(10) Pub. No.: US 2019/0293854 A1
(43) Pub. Date: Sep. 26, 2019

(54) Method For Producing A Light-Guiding Element, Light-Guiding Element, Illumination Element And Operating Element For A Vehicle

(71) Applicant: ZF FRIEDRICHSHAFEN AG, Friedrichshafen (DE)

(72) Inventors: Alexander Kirilenko, Diepholz (DE); Joachim Spratte, Osnabrueck (DE)

(73) Assignee: ZF FRIEDRICHSHAFEN AG, Friedrichshafen (DE)

(21) Appl. No.: 16/340,993

(22) PCT Filed: Sep. 13, 2017
(86) PCT No.: PCT/EP2017/072959

§ 371 Date: Apr. 10, 2019

(30) Foreign Application Priority Data
Oct. 13, 2016 (DE) 10 2016 219 924.2

(51) Int. Cl. F21V 8/00; C03C 25/104

(52) U.S. Cl. CPC G02B 6/001; B60Q 3/20; C03C 25/104; G02B 6/0006

(57) ABSTRACT

The invention relates to a method for producing a fiber optic element (102). An optical fiber (106) is coated at least in part with a transparent metal layer (108) by sputtering at least one metallic diffuser thereon.

The present invention relates to a method for producing a fiber optic element, a fiber optic element, a lighting element, and a control element for a vehicle.

DE 103 20 237 B4 describes a method for producing transparent, galvanic refined thermoplastic components with symbols, in which a thermoplastic component made of a transparent, amorphous plastic is coated with an opaque layer made of an acrylonitrile butadiene styrene (ABS) that can be electroplated. The electroplating layer is subsequently removed from the symbol by a burning laser beam. An electroplating layer is then applied to the remaining coating.

Based on this, the present invention provides an improved method for producing a fiber optic element, an improved fiber optic element, an improved lighting element, and an improved control element for a vehicle according to the independent claims. Advantageous embodiments can be derived from the dependent claims and the following description.

A method for producing a fiber optic element is presented, in which an optical fiber is at least partially coated with a transparent metal layer by sputtering at least one metallic diffuser thereon.

A fiber optic element can be an optical component for conducting light. By way of example, the fiber optic element can be designed to diffuse or focus light. In particular, the fiber optic element can be designed to diffuse light such that an optical effect is obtained resembling incandescence. An optical fiber can be a single- or multi-part body of the fiber optic element. The optical fiber can be made of a translucent, in particular transparent, material. In particular, the optical fiber can be made of a plastic, e.g. polycarbonate or acrylonitrile butadiene styrene copolymer, or a composite of numerous different plastics. The optical fiber can have a curved surface, at least in part, wherein the curved surface is coated with the metal layer in the coating step.

A diffuser can be a target functioning as a cathode. A layer of atomic thickness can be removed by the diffuser through ion bombardment, which can accumulate on the optical fiber functioning as a substrate, in order to form the metal layer. By way of example, the metal layer can be such that it does not entirely absorb light beams, but instead allows a portion to pass through it, depending on the thickness of the coating. From an visual perspective, the metal layer can resemble chrome plating.

The approach described herein is based on the knowledge that a transparent component with a metallic surface can be obtained by sputtering. In particular in the field of user interfaces, also referred to as Human Machine Interfaces or HMI, lighting is increasingly subjected to higher requirements regarding the performance and design thereof. In particular, metallic surfaces are limited in terms of their uses for lighting technology. On one hand, substances can be galvanized and exposed in certain areas, in order to obtain a screening. On the other hand, it is possible to obtain metallic transparent surfaces by means of in-mold labeling technologies, abbreviated IML. However, the films used for the IML in-mold decoration can only be shaped to a limited extent with small radii and deep molds.

The approach presented herein allows a thin metal layer to be applied to transparent materials, e.g. polycarbonate or ABS through a sputtering process, in particular on components with strongly curved surfaces or sharp edges, without qualitative losses. Depending on the thickness of the metal layer, not all of the light to which the metal layer is subjected is absorbed, and at least a portion thereof passes through the coating. By way of example, a component can be created with this sputtering coating that resembles a chrome-plated component from a visual perspective. In contrast to producing a chrome-plating through electroplating, the thickness of which prevents any transmission of light, a metal layer applied through sputtering can be transparent.

According to one embodiment, the optical fiber can be coated with the metal layer in the coating step in order to make the optical fiber reflective. The metal layer can thus be designed to make the optical fiber reflective. As a result, a fiber optic element can be obtained at low costs that has the appearance of a high quality element.

According to another embodiment, a plastic element can be coated to form the optical fiber. Depending on the embodiment, the plastic element can be made of a single plastic or a composite of numerous different plastics. As a result, an optical fiber can be obtained that has specific optical properties. Moreover, the optical fiber can be produced in an injection molding process particularly inexpensively, thus reducing the production costs for the fiber optic element.

It is advantageous when the optical fiber is coated in the coating step by magnetron sputtering of the diffuser. As a result, it can be ensured that a metallic layer of high quality is obtained.

Moreover, the method can comprise a step for applying a protective coating to the metal layer. By way of example, the protective coating can be a transparent layer made of an abrasion-resistant, chemical-resistant material such as lacquer or glass. As a result, the wear-resistance of the fiber optic element can be improved.

It is of particular advantage when, according to another embodiment, the protective coating is applied to the metal layer by sputtering a glass diffusor in the application step. Such a protective coating offers the advantage of a particularly effective abrasion resistance and chemical resistance. Another advantage is that the protective coating can also be applied to sharp-edged or strongly shaped surfaces, without qualitative losses.

The approach presented herein also results in a fiber optic element with an optical fiber, to which a transparent metal layer is at least partially applied by sputtering at least one metallic diffuser thereon. Such a fiber optic element offers the advantage of a high surface quality with relatively low production costs.

According to one embodiment, the optical fiber can have a core and a sheath that at least partially encompasses the core. The core and the sheath can have different optical properties. The metal layer can be applied to the sheath. By way of example, the core and sheath can be made of the same plastic or different plastics. The optical fiber can be produced, for example, in an inexpensive injection molding process. With this embodiment, depending on the materials used for the core and the sheath, different emission characteristics of the fiber optic element can be obtained with relatively low production expenditures.

By way of example, the core can be designed to diffuse light more strongly than the sheath. As a result, when light passes through the fiber optic element, a so-called ghost light effect can be obtained that resembles incandescence.

According to another embodiment, the optical fiber can have a semispherical or semielliptical cross section. The sheath layer can be applied to a curved section of the optical fiber. As a result, light can be diffused as broadly as possible.

Furthermore, the approach presented herein results in a lighting element with the following features:

a fiber optic element according to any of the preceding embodiments; and

a light source for bundling light beams in the fiber optic element.

The light source can be one or more light emitting or laser diodes. In particular, the lighting element can form a component of a control element for a vehicle.

Lastly, the approach presented herein results in a control element for a vehicle, wherein the control element has at least one lighting element according to any of the preceding embodiments. A control element can be a shift lever such as a gearshift lever or a steering column lever, a shifter, a slider, or a knob, or also a decorative surface such as a central console for the vehicle. Such a control element offers the advantage of a particularly high-quality appearance and a high level of operating comfort. Advantageously, the control element can be produce inexpensively.

The invention shall be explained in greater detail based on the attached drawings. Therein:

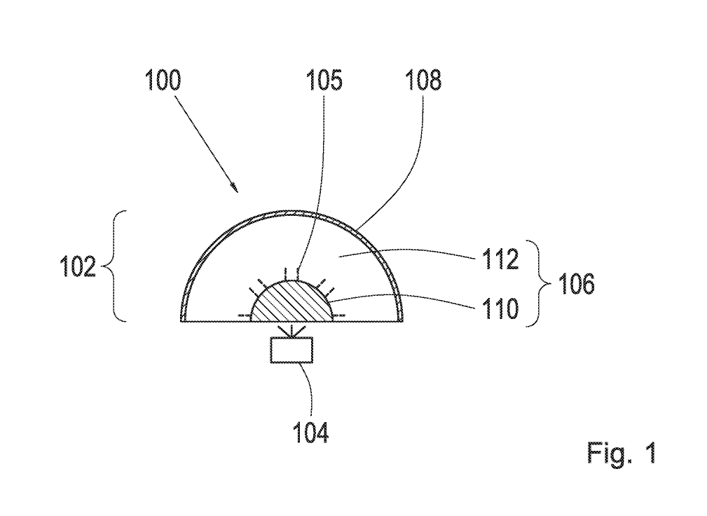

FIG. 1 shows a schematic illustration of a lighting element according to an exemplary embodiment;

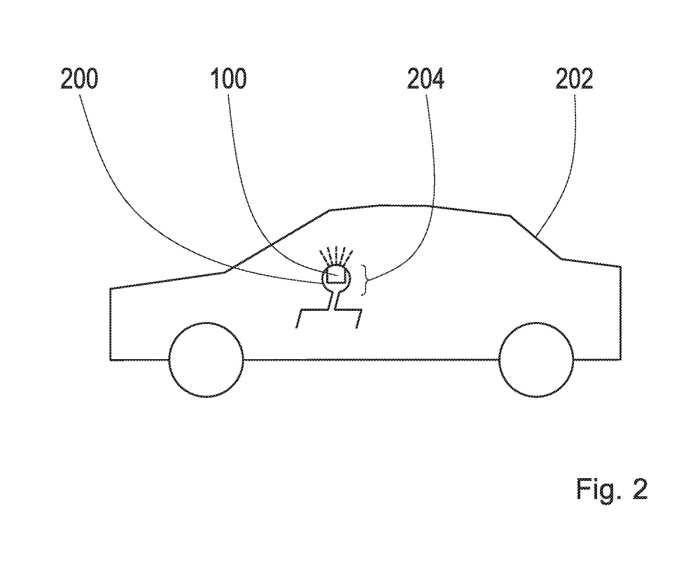

FIG. 2 shows a schematic illustration of a control element according to an exemplary embodiment; and

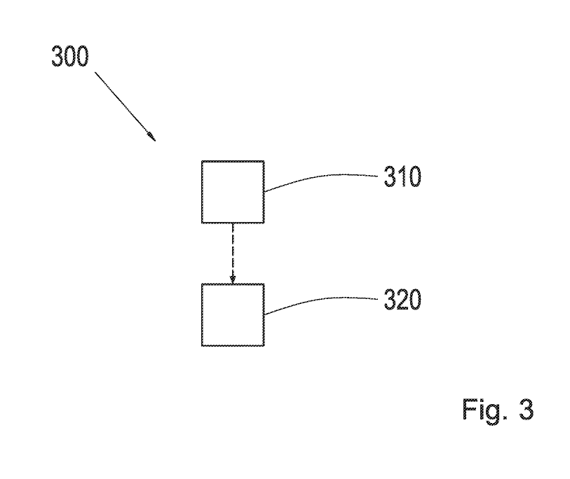

FIG. 3 shows a flow chart for a method for producing a fiber optic element according to an exemplary embodiment.

In the following description of preferred exemplary embodiments, the same or similar reference symbols shall be used for the elements having similar functions shown in the various figures, wherein there shall be no repetition of the descriptions of these elements.

FIG. 1 shows a schematic illustration of a lighting element 100 according to an exemplary embodiment. The lighting element 100 comprises a fiber optic element 102, illuminated by a light source 104, in this case a light emitting diode. According to this exemplary embodiment, the fiber optic element 102 is designed to diffuse the light beams 104 entering the fiber optic element 102 from the light source 104 such that an observer of the lighting element 100 has the impression that the lighting element 100 is incandescent, also referred to as having a ghost light effect. In order to obtain this effect, the fiber optic element 102 comprises an optical fiber 106, which is coated at least in sections by a transparent metal layer 108. The metal layer 108 is applied to the optical fiber 106 in a sputtering process, i.e. by sputtering a corresponding metallic diffuser thereon, in particular through magnetron sputtering. As a result, the metal layer 108 is thin enough that a certain portion of the light beams 105 conducted by the optical fiber 106 are transmitted by the metal layer 108. Depending on the material used for the diffuser, the metal layer 108 resembles a strongly reflective chrome plating after the sputtering.

According to this exemplary embodiment, the optical fiber 106 has a flat base, in which the light from the light source 104 is bundled. On a side opposite the base, the optical fiber 106 has a curved surface, which can be seen at least in part by an observer when the lighting element 100 is installed.

Alternatively, the metal layer 108 is applied in order to obtain a matte or brushed appearance of the component. In doing so, surface defects are to be prevented as much as possible in the optical fiber 106, because these stand out after the sputtering.

According to this exemplary embodiment, the optical fiber 106 is a composite of two sub-sections with different diffusing properties, taking the form of a core 110 and a sheath 112 that partially encompasses the core, wherein the core 110 is made of a strongly diffusing substance, and the sheath 112 is made of a less strongly diffusing substance. Depending on the exemplary embodiment, the core 110 and the sheath 112 may also differ from one another regarding other optical properties. By way of example, the core 110 and the sheath are formed from different plastics in an injection molding process. Alternatively, the optical fiber 106 can also be formed as a single element made of plastic or some other suitable transparent material.

The actual light core of the lighting element 100 is thus a strongly diffusing material, which is coated with a material that has little or no diffusing properties, in order to form the sheath 112. The sputtering layer 108 is then applied thereto. If the structure is backlit by the light source 104, the central core 110 will be very bright, and the sheath 112 will generate a light veil, or no light at all. The ghost light effect is then obtained in conjunction with the metallic appearance of the metal layer 108.

By way of example, the optical fiber 106 according to FIG. 1 has a semispherical cross section, wherein the metal layer 108 is applied to a curved section of the optical fiber 106. The curved section is a side of the lighting element 100 facing the observer. The light source 104 is located opposite a flat section of the core 110, which likewise has a semispherical cross section. The flat section of the core 110 and the flat section of the sheath 112 adjoining this section have no metal coating.

Alternatively, the optical fiber 106 may have a semielliptical cross section, depending on the application, or it may have a cross section with some other geometrical shape.

FIG. 2 shows a schematic illustration of a control element 200 according to an exemplary embodiment. The control element 200 for a vehicle 202, in this case a gearshift lever, comprises the lighting element 100, this being a lighting element like that described above in reference to FIG. 1. Depending on the exemplary embodiment, numerous lighting elements 100 can also be integrated in the control element 200. The lighting element 100 is integrated in the control element 200 such that the section of the lighting element 100 coated with the sputtered metal layer is part of a surface of the control element 200, or is flush thereto. The lighting element 100 displays light symbols on the control element 200 or illuminates the control element 200 on the whole, or sections of the control element 200 by means of a suitable lighting effect, which may vary, depending on the design of the optical fiber or the metal layer. By way of example, a knob 204 of the control element 200 in the form of a gearshift lever can be formed entirely or in part by the lighting element 100 or numerous different lighting elements 100.

FIG. 3 shows a flow chart for a method 300 for producing a fiber optic element according to an exemplary embodiment, such as a fiber optic element described above in reference to FIGS. 1 and 2. In step 310, an optical fiber is at least partially coated in an appropriate sputtering process with the transparent metal layer.

According to one exemplary embodiment, a protective layer is applied to the metal layer in an optional step 320 after the sputtering. According to one exemplary embodiment, the protective layer is applied to the metal layer by sputtering a glass diffuser in the form of a glass layer.

According to one exemplary embodiment, the step 310 comprises the following sequential sub-steps.

First, a substrate that is to be sputtered, i.e. the optical fiber, is pre-cleaned in an ultrasound bath at 60° C. in a pH neutral cleaning solution, and subsequently rinsed in ultrapure water.

The substrate is subsequently cured in a high-vacuum chamber. The heater remains at a specific temperature during the entire coating process, such that the substrate is also heated.

The surface of the substrate is then activated by a sputtering etcher, and lightly etched. The substrate rotates thereby at a rotational rate of two revolutions per minute.

Subsequently, a chrome plating is generated using a magnetron sputtering source.

Lastly, a post-curing takes place for approximately 20 minutes.

One advantage of this method is that geometries can also be obtained therewith, that could not be obtained with a comparably transparent IML reverse film injection, or could only be obtained with a great deal of difficulty. By way of example, small radii and greater component depths and surface angles can be coated therewith.

Moreover, a glass sputtering may take place in step 320, after the metal sputtering. In this case, a glass layer is applied to the substrate in a sputtering process similar to that in step 310. In contrast to an abrasion resistant lacquer, such a glass layer offers the advantage of a better abrasion resistance and better chemical resistance to suntan lotion or similar chemicals. There is also the further advantage that the glass layer can be applied by means of sputtering to sharp-edged and strongly deformed surfaces, while an abrasion resistant lacquer tends to run in sharper angles.

The method 300 makes it possible to generate new optical effects on different shapes, e.g. a so-called ghost light effect. The observer looks at the outside of the metallic surface of the fiber optic element thereby. When the fiber optic element is illuminated, the observer sees an inner incandescence due to the light transmission of the sputtered surface. This incandescence does not originate directly in the surface, where the sputtering layer is applied, but instead comes from a light core of the system located deeper in the interior.

### REFERENCE SYMBOLS

100 lighting element
102 fiber optic element
104 light source
105 light beams
106 optical fiber
108 metal layer
110 core
112 sheath
200 control element
202 vehicle
204 knob
300 method for producing a fiber optic element
310 coating step
320 applications step

1. A method for producing a fiber optic element, wherein an optical fiber is at least partially coated with a transparent metal layer by sputtering at least one metallic diffuser thereon in a coating step.

2. The method according to claim 1, in which the metal layer is designed to make the optical fiber reflective.

3. The method according to claim 1, in which a plastic element forming the optical fiber is coated in the coating step.

4. The method according to claim 1, in which the optical fiber is coated by magnetron sputtering of the diffuser thereon in the coating step.

5. The method according to claim 1, with a step for applying a protective layer to the metal layer.

6. The method according to claim 5, in a glass diffuser is applied to the metal layer by sputtering.

7. A fiber optic element with an optical fiber, to which a transparent metal layer is applied at least in part to by sputtering at least one metallic diffuser thereon.

8. A fiber optic element according to claim 7, in which the optical fiber has a core and a sheath that at least partially encompasses the core, wherein the core and the sheath have different optical properties, wherein the metal layer is applied to the sheath.

9. The fiber optic element according to claim 8, in which the core is designed to diffuse light more strongly than the sheath.

10. The fiber optic element according to claim 7, in which the optical fiber has a semispherical or semielliptical cross section, wherein the metal layer is applied to a curved section of the optical fiber.

11. A lighting element that has the following features:
a fiber optic element according to claim 7; and
a light source for bundling light beams in the fiber optic element.

12. A control element for a vehicle, wherein the control element has at least one lighting element according to claim 11.

13. The method according to claim 2, in which a plastic element forming the optical fiber is coated in the coating step.

14. The method according to claim 2, in which the optical fiber is coated by magnetron sputtering of the diffuser thereon in the coating step.

15. The method according to claim 3, in which the optical fiber is coated by magnetron sputtering of the diffuser thereon in the coating step.

16. The method according to claim 2, with a step for applying a protective layer to the metal layer.

17. The method according to claim 3, with a step for applying a protective layer to the metal layer.

18. The method according to claim 4, with a step for applying a protective layer to the metal layer.

19. The fiber optic element according to claim 8, in which the optical fiber has a semispherical or semielliptical cross section, wherein the metal layer is applied to a curved section of the optical fiber.

20. A lighting element that has the following features:
a fiber optic element according to claim 8; and
a light source for bundling light beams in the fiber optic element.
